(19) United States
(12) Patent Application Publication
(10) Pub. No.: US 2017/0066292 A1
(43) Pub. Date: Mar. 9, 2017

(54) Tread Comprising A Strong-Contrast Texture In A Groove

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: Stéphanie CAMBON, Clermont-Ferrand Cedex 9 (FR); Jonathan LEJEUNE, Clermont-Ferrand Cedex 9 (FR)

(21) Appl. No.: 15/123,083

(22) PCT Filed: Mar. 9, 2015
(86) PCT No.: PCT/EP2015/054845

§ 371 Date: Sep. 1, 2016

(30) Foreign Application Priority Data
Mar. 10, 2014 (FR) 1451916

(51) Int. Cl. B60C 11/13; B60C 11/03

(52) U.S. Cl. CPC B60C 11/1353; B60C 11/1307; B60C 11/0323; B60C 2011/1361

(57) ABSTRACT

A tread (2), said tread having a tread surface (20) and a plurality of grooves (21), at least one groove having, in cross section, an undulating overall shape with entirely open groove parts (210) at the tread surface (20) and completely or partially closed groove parts (211) at said tread surface (20). The tire is characterized in that the open groove parts (210) comprise a contrasting texture (3) in the tread, the texture (3) having a plurality of elements that protrude from or are recessed into the surface of the groove. The texture (3) is absent from the closed groove parts (211).

### FIELD OF THE INVENTION

The present invention relates to a tread for a tire, said tread having a tread surface and a plurality of grooves.

The invention also relates to a tire comprising such a tread.

### PRIOR ART

In order to mould the tread of a tire, it is known practice to use moulding elements fixed in a mould. What is meant by a moulding element is any element of the mould which has a moulding surface that allows part of the tread of a tire to be moulded. A moulding element can thus be a block fitted on a segment of the mould or else a rib attached to the radially inner surface of the mould.

It is possible to create a moulding element using a selective fusion method more commonly referred to as sintering. This method uses a beam of energy to fuse a metallic powder. A “beam of energy” means electromagnetic radiation (for example a laser beam) or a beam of particles (for example an electron beam).

A sintering method using a laser, referred to below as a laser sintering method, is known from document EP1641580. In that document, a first layer of metallic powder is spread on a plate. All or some of the particles of this first layer of powder are then agglomerated by the beam of a laser according to the shape of the object that is to be obtained. Once this step has been performed, a second layer of powder is spread on the first layer of powder so that it can be selectively fused in turn using the laser. By repeating these operations of spreading a layer and fusing using a laser, a sintered object is built up layer by layer.

Such a sintered object is shown notably in FIG. 3 of document EP0868955. In that figure, the layered structure of the sintered object is easily distinguished, said sintered object being a moulded element intended to be attached inside a mould for a tire. However, this layered structure causes level lines which are the mirror image of this structure to appear in the grooves of the tread. This phenomenon of level lines is augmented by the curvilinear nature of the mould. These level lines give the tire an unattractive appearance.

Document WO 2011/039194 discloses a tire comprising a tread provided with a plurality of grooves. Each groove has, in cross section, an undulating overall shape with entirely open groove parts at the tread surface and closed groove parts.

There is a need to provide a solution that makes it possible to use the laser sintering method in order to manufacture the mould for moulding a tire provided with undulating grooves, while attempting to improve the appearance of this tire.

### DEFINITIONS

A “tire” means all types of resilient tread, whether or not it is subjected to an internal pressure.

A “rubber material” means a diene elastomer, that is to say, in a known way, an elastomer which is based, at least partially (i.e. is a homopolymer or a copolymer), on diene monomers (monomers bearing two conjugated or non-conjugated carbon-carbon double bonds).

The “tread” of a tire means a quantity of rubber material delimited by lateral surfaces and by two main surfaces, one of which, referred to as the tread surface, is intended to come into contact with a road surface when the tire is being driven on.

A “texture” means a set of organized elements.

The “sidewall” of a tire means a lateral surface of the tire, said surface being disposed between the tread of the tire and a bead of this tire.

A “strand” means a filiform element, the height of which is at least equal to twice the diameter of a disc having the same surface area as the mean cross section of the strand.

“Lamellae” means elongate strands which have a length at least equal to twice their height.

### SUMMARY OF THE INVENTION

The invention relates to a tread for a tire, said tread having a tread surface and a plurality of grooves, at least one groove having, in cross section, an undulating overall shape with entirely open groove parts at the tread surface and completely or partially closed groove parts at said tread surface. The open groove parts comprise a contrasting texture in the tread, the texture having a plurality of elements that protrude from or are recessed into the surface of the groove. The texture is absent from the closed groove parts.

The texture makes it possible to create a visual contrast with the tread parts that do not have this texture. When the texture is present in a groove, this visual contrast accentuates the depth of this groove for an observer of the tire. Moreover, by using a texture in the open parts of the groove, the presence of level lines in this groove is concealed. Starting from a particular state of wear of the tread, the closed groove parts open. By not covering these closed groove parts with the texture, the observer is provided with a visual indication that he has reached an intermediate level of wear of the tread. At this level of wear, the concealed channels open at the surface of the tread and this tread then enters another operating phase.

In one non-limiting embodiment, at least 30% of the protruding elements of the texture form an angle α of greater than 40° with respect to a plane tangent to the surface of the groove, and at most 25% of the protruding elements of the texture form an angle α of less than 20° with respect to the tangent plane.

In this way, the capacity of the texture to trap light is improved further.

In one non-limiting embodiment, all or some of the protruding elements are strands distributed through the texture at a density at least equal to one strand per square millimetre (mm²), each strand having a mean cross section of between 0.003 mm² and 1 mm².

In another non-limiting embodiment, all or some of the protruding elements are substantially mutually parallel lamellae, the spacing of the lamellae in the texture being at most equal to 0.5 mm, each lamella having a mean width of between 0.03 mm and 0.25 mm.

In another non-limiting embodiment, all or some of the protruding elements form parallelepipeds having a side length of between 0.05 mm and 0 5 mm and a height of between 0.05 mm and 0.5 mm, the distance between two adjacent parallelepipeds in the texture being between 0.05 mm and 0.5 mm.

In another non-limiting embodiment, the protruding elements have variable shapes and distances between protruding elements in the texture.

In one non-limiting embodiment, the recessed elements form openings in the surface of the groove and the texture comprises a plurality of openings, these openings being distributed through the texture at a density at least equal to one opening per square millimetre (mm²), these openings having equivalent diameters of between 0.03 mm and 1.2 mm.

The texture is thus more durable. Specifically, since this texture is made up of elements that are recessed into the surface of the groove, the impact on this texture of rubbing against stones is low.

Also proposed is a tire comprising a tread according to any one of the preceding features.

### BRIEF DESCRIPTION OF THE DRAWINGS

Other features and advantages of the invention will become apparent from the following description, given by way of non-limiting example, with reference to the attached drawings in which:

FIG. 1 schematically shows a perspective view of a part of a tire having a tread in accordance with the prior art;

FIG. 2 schematically shows a view in cross section of the tread of a tire, said tread having a groove with a texture in accordance with the invention;

FIG. 3 schematically shows a view in cross section of a groove of the tread from FIG. 2 with the particular texture;

FIG. 4 shows a part of the texture from FIG. 2, according to a first embodiment of the invention;

FIG. 5 shows a part of the texture from FIG. 2, according to a second embodiment of the invention;

FIG. 6 shows a part of the texture from FIG. 2, according to a third embodiment of the invention;

FIG. 7 shows a part of the texture from FIG. 2, according to a fourth embodiment of the invention;

FIG. 8 shows a part of the texture from FIG. 2, according to a fifth embodiment of the invention; and

FIG. 9 shows an enlarged view of a cavity of a recessed element of the texture from FIG. 8.

In the following description, elements which are substantially identical or similar will be denoted by identical references.

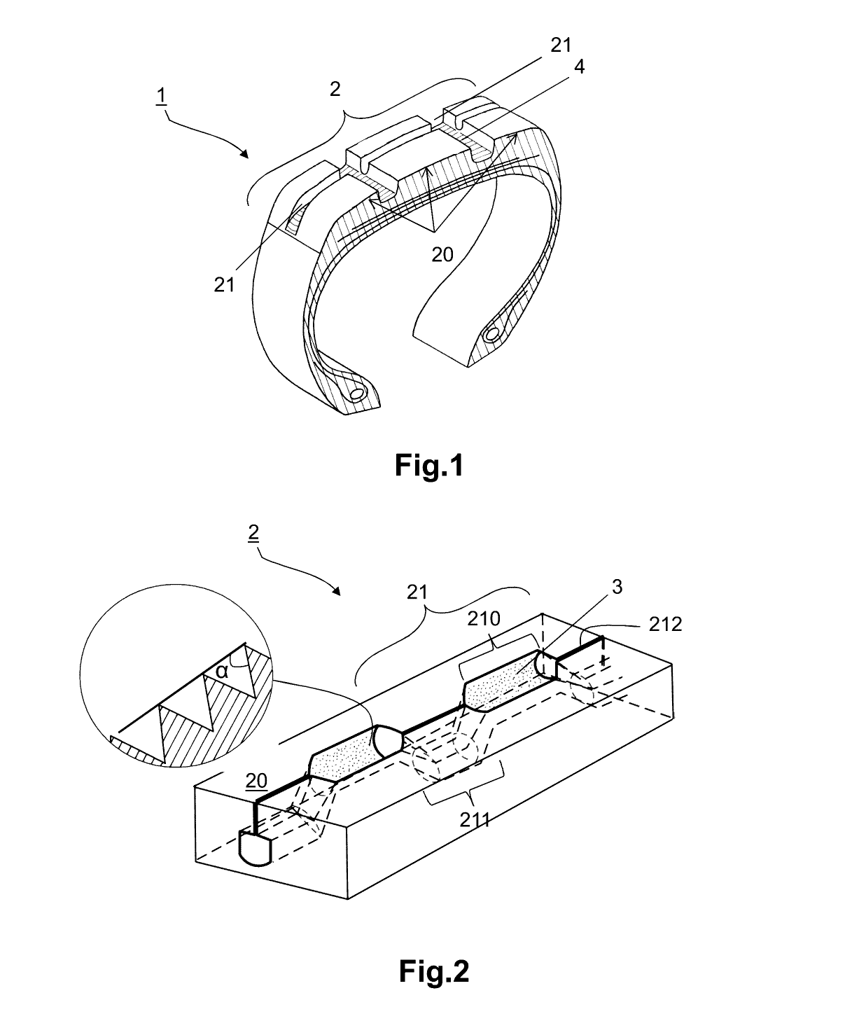

FIG. 1 shows a part of the tire 1 having a tread 2 according to the prior art. As can be seen, the tread 2 has a tread surface 20 and grooves 21. The tread surface 20 (also known as the useful region) is intended to come into contact with a road surface when the tire 1 is being driven on. The grooves 21 (also known as tread patterns) make it possible notably to evacuate water and thereby improve the grip of the tire 1 on a wet road surface. On account of the laser sintering method used, the grooves have level lines 4. In the example illustrated, the level lines are located notably at the bottom of the groove.

FIG. 2 shows a view in cross section of the tread 2 of a tire 1, according to a non-limiting embodiment of the invention. The tread 2 has a tread surface 20 and grooves 21. In one non-limiting embodiment, at least one groove 21 has an undulating overall shape in the depth of the tread 2. In another non-limiting embodiment, each groove 21 has an undulating overall shape in the depth of the tread 2.

As illustrated, a groove 21 has a surface and has, in cross section, an undulating overall shape with entirely open groove parts 210 at the tread surface 20 and completely or partially closed groove parts 211 at this tread surface 20. The open groove parts 210 comprise a contrasting texture 3 in the tread. The open (or external) groove parts 210 open onto the tread surface 20 when the tire 1 is in the new state, while the closed (or internal) groove parts 211 are located inside the tread 2, in the depth thereof (that is to say under the tread surface 20) when the tire 1 is in the new state. When the tread 2 becomes worn, at a certain level of wear, these closed parts 211 open onto the tread surface 20.

It will be noted that the closed groove parts 211 are closed over all or part of the tread surface 20. Specifically, said grooves 211 have a slit 212 which extends into the depth of the tread 2 and opens onto the tread surface 20, as illustrated in FIG. 2. This slit corresponds to a lamella in the moulding negative of a groove.

In one non-limiting embodiment, the texture 3 is absent from the closed groove parts 211, as illustrated in the non-limiting embodiment in FIG. 2.

Thus, the fact that the texture 3 is used only in the groove parts 210 which are open at the tread surface 20 makes it possible to conceal, in the new state, the presence of level lines in this groove. Specifically, at a certain level of wear, the closed parts 211 will be exposed and the level lines in these closed parts will then be visible to an observer of the tire.

This allows an observer to tell the difference visually between the open groove parts 210 (which appear darker) and the closed groove parts 211 (which appear lighter) when the tread is worn and exposes the closed groove parts 211. The observer can clearly see that his tire 1 is worn.

FIG. 3 illustrates a view in cross section of a groove 21. A groove 21 has a groove bottom 213, walls 214 flanking the groove bottom and transition regions 215 (also known as connecting regions) between the walls 214 and the groove bottom 213, these transition regions 215 being curved and having a radius of around 1 mm in one non-limiting example. It will be noted that the texture 3 is illustrated schematically in a groove 21 at the bottom 213 and in the transition regions 215 in one non-limiting example, in a zoomed-in view. It will also be noted that the wall 214 is shown here as extending perpendicularly to the bottom 213 of the groove. In a variant, this wall 214 may be at an angle other than 90° with respect to the bottom 213.

In a first non-limiting embodiment illustrated in FIG. 3, all or some of the grooves 21 comprise a texture 3 extending only over the groove bottom 213 and over at least a part of the transition regions 215 associated with this groove bottom, said texture 3 contrasting with the rest of the tire 2. “At least a part of a transition region 215” means that the texture extends over at least 25% of the surface of this transition region 215. The texture 3 does not extend over the walls 214. It is thus absent from the walls 214. This first embodiment conceals the level lines that are located at the bottom 213 and in the transition regions 215 of the grooves 21. This is because these level lines at the bottom are particularly visible to an observer of the tire.

In a second non-limiting embodiment illustrated in FIG. 2, all or some of the grooves 21 comprise a texture 3 extending over the entire interior of the grooves 21, namely over the groove bottom 213, over the transition regions 215 associated with this groove bottom and over the walls 214 of the groove, said texture 3 contrasting with the rest of the tire 2.

The texture 3 thus makes it possible to conceal the level lines. Furthermore, the fact that the texture 3 is disposed in the grooves 21 makes it possible to give said texture 3 greater durability. Specifically, the impact of mechanical attack on the texture, such as rubbing against stones, is low.

According to a first non-limiting embodiment of the texture 3, the texture 3 comprises a plurality of elements that protrude from the surface of the groove. The effect of these protruding elements is to “trap” a large amount of the incident light rays that strike the texture 3. In this first embodiment, the texture 3 (known as “velvet”) makes it possible to obtain a visual appearance of the “velvet” type since the protruding elements absorb light and thus make the grooves 21 blacker. Owing to their structure and the fact that they are “inlaid” in the grooves 21, these protruding elements furthermore make it possible to evacuate water, mud and dust more easily from the grooves 21.

According to one non-limiting variant embodiment, at least 30% of the protruding elements of the texture 3 form an angle α of greater than 40° with respect to a plane X tangent to the surface of a groove 21 (surface of the bottom 213, surface of the transition regions 215, surface of the walls 214), and at most 25% of the protruding elements of the texture form an angle α of less than 20° with respect to the tangent plane X. The protruding elements, said tangent plane X and said angle α are illustrated schematically in the zoomed-in part of the texture 3 in FIG. 2. It will be noted that the angle α is the angle between the tangent plane X and the side of the protruding elements. This variant is applicable to the protruding elements 6 and 7 described below.

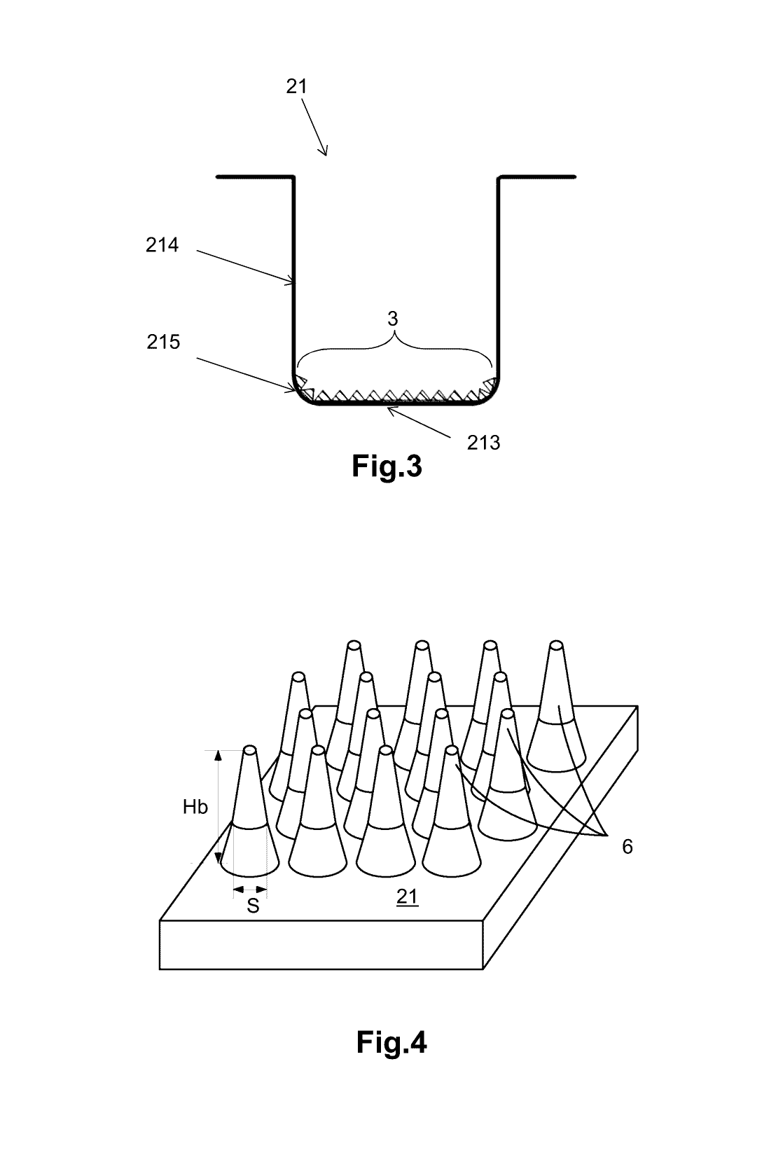

FIG. 4 illustrates the texture 3 according to a first non-limiting variant embodiment of the first embodiment. In this variant, all or some of the protruding elements are strands 6 distributed through the texture 3 at a density at least equal to one strand per square millimetre (mm²), each strand having a mean cross section S of between 0.003 mm² and 1 mm². It will be noted that the mean cross section of each strand corresponds to the mean of the cross sections S measured at regular intervals from the base of the strand. The strands 6 have a conical overall shape with a cross section that decreases over the height Hb of these strands.

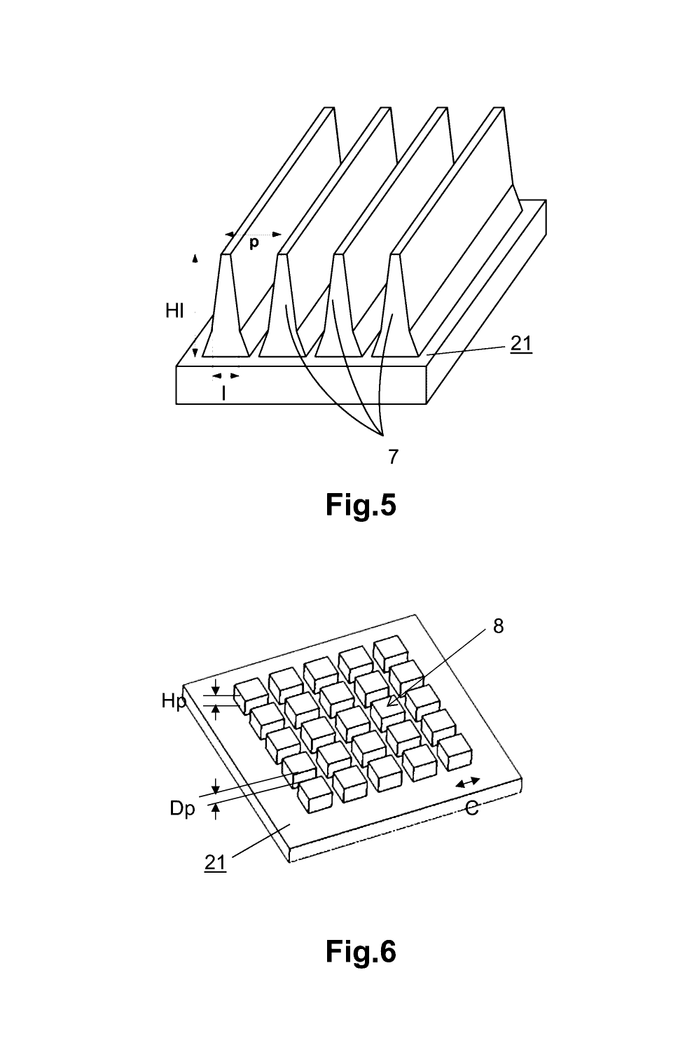

FIG. 5 illustrates the texture 3 according to a second non-limiting variant embodiment of the first embodiment. In this variant, all or some of the protruding elements are substantially mutually parallel lamellae 7, the spacing P of the lamellae in the texture being between 0.1 mm and 0.5 mm, each lamella 7 having a mean width of between 0.03 mm and 0.25 mm. It will be noted that the mean width corresponds to the mean of the widths 1 measured at regular intervals over the height H1 of the lamella, the height of each lamella being between 0.05 and 0.5 mm.

In another variant embodiment, the texture has a combination of strands 6 and lamellae 7.

FIG. 6 illustrates the texture 3 according to a third non-limiting variant embodiment of the first embodiment. In this variant, all or some of the protruding elements form parallelepipeds 8 having a side length C of between 0.05 mm and 0.5 mm and a height Hp of between 0.05 mm and 0.5 mm, the distance Dp between two adjacent parallelepipeds 8 in the texture being between 0.05 mm and 0.5 mm.

In another variant embodiment, the texture has a combination of elements in relief 6, 7 and 8, or 6 and 8, or 7 and 8 described above.

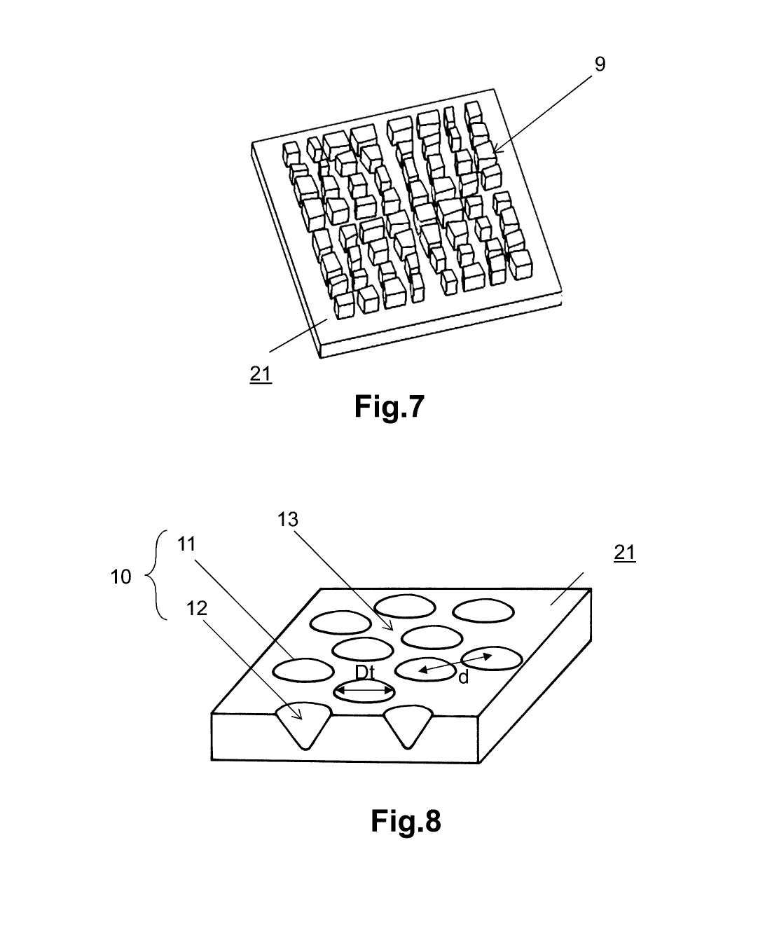

FIG. 7 illustrates the texture 3 according to a fourth non-limiting variant embodiment of the first embodiment. In this variant, the protruding elements 9 have variable shapes and distances between protruding elements in the texture 3. This variant makes it possible to improve the aesthetic appearance of the texture 3.

According to a second non-limiting embodiment of the texture 3, the texture 3 comprises a plurality of elements 10 (also known as holes) that are recessed into the surface of the grooves 21 (surface of the bottom 213, surface of the transition regions 215, surface of the walls 214). The recessed elements 10 are made up of openings 11 in the surface of the grooves, and of associated cavities 12 extending into the depth of the grooves.

Thus, the texture 3 has a plurality of openings 11 in the surface of the groove, said openings 11 being distributed through the texture 3 at a density at least equal to one opening per square millimetre (mm²) and having (in the groove surface) equivalent diameters Dt of between 0.03 mm and 1.2 mm.

In one non-limiting embodiment, the openings 11 occupy at least 30% of the texture 3.

According to other non-limiting embodiments, the openings 11 occupy at least 50% of the texture 3, or even more than 70%. It will be noted that the greater the rate of occupation of the texture by the openings, the better the concealment of the level lines brought about by the moulding method is, and the better this texture contrasts with the rest of the tread (notably with the tread surface).

The openings 11 continue into the depth of the grooves 21 to form cavities 12.

The effect of these cavities 12 is to “trap” a large amount of the incident light rays that strike the texture 3. Specifically, since the cavities 12 are recessed into the groove 21, the impact of mechanical attack on the texture, such as rubbing against stones, is lower than for protrusions. In this second embodiment, the texture 3 (known as “velvet”) makes it possible to obtain a visual appearance of the “velvet” type since the cavities absorb light and thus make the grooves 21 blacker. The visual effect of the grooves is improved.

In one non-limiting embodiment, all or some of the cavities 12 have a depth at least equal to 0.1 mm. In one non-limiting variant embodiment, all or some of the cavities 12 have a depth of between 0.2 mm and 0.6 mm. This ensures that a large amount of incident light rays that strike the texture 3 are trapped by said texture and, since the depth of the cavities is limited, also prevents the mechanical strength of the grooves 21 from deteriorating excessively.

FIG. 8 illustrates the texture 3 according to a first non-limiting variant of this second embodiment. In this variant, all or some of the cavities 12 are in the form of cones which extend into the depth of the groove 21 and lead onto the surface of the groove 21, forming circular openings 11. The cavities 12 thus have a cross section which decreases with depth. This improves the contrast of the texture 3 and thus of the groove 21 with respect to the rest of the tread 2. It will be noted that in this variant, the openings 11 of the cavities 12 are not in contact. The openings 11 are separated by intermediate regions 13. Moreover, the openings 11 are distributed regularly over the surface of the groove 21 such that the distance d between each opening in the texture 3 is similar overall.

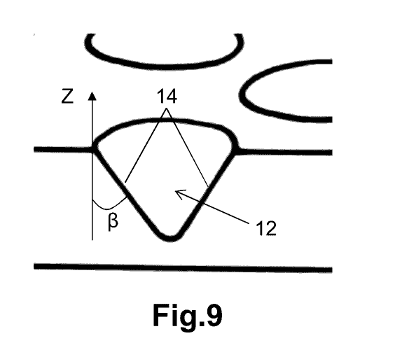

FIG. 9 is a zoomed-in view of a cavity 12 of a recessed element 10 of the texture from FIG. 8. In one non-limiting embodiment, all or some of the cavities have at least one wall 14 which, in cross section, forms an angle β of between 10° and 60° with respect to a direction Z perpendicular to the texture 3.

Each time a light ray strikes a wall 14 of the cavity 12, this ray is reflected by said wall 14. The direction of reflection of the light ray depends on the initial direction of this light ray and on the inclination angle of the wall 14. Thus, depending on this initial direction and on this inclination angle, the light ray can be sent towards another wall 14 of the cavity. By contrast, the light ray can be sent to the outside of the cavity, for example directly towards an observer. In the first case, the light ray is “lost” in the cavity and will no longer be perceptible to an observer. In the second case, the observer can perceive the light ray and the texture can then appear to be lighter and thus to contrast less with the rest of the tread. Choosing a cavity 12 having at least one wall 14 which forms an angle β of between 10° and 60° ensures that a large part of the light rays entering the cavity 12 will be absorbed by this cavity under the effect of multiple reflections inside the cavity.

This improves the contrast of the texture 3 (and notably of the grooves 21) with respect to the rest of the tire (notably with respect to the sidewall or with respect to the tread surface), while preserving the same rate of occupation of the texture by the cavities. Moreover, with this wall inclination, the strength of the texture is improved overall, notably in the event of repeated rubbing against stones.

Thus, the tread 2 described is suitable for being integrated into a tire 1 made of rubber material for a motor vehicle. A motor vehicle means any type of motorized vehicle, such as cars or heavy goods vehicles.

The tire 1 thus comprises a tread 2, said tread 2 having a tread surface 20 and a plurality of grooves 21, at least one groove having, in cross section, an undulating overall shape with entirely open groove parts 210 at the tread surface 20 and completely or partially closed groove parts 211 at said tread surface 20. The open groove parts 210 comprise a contrasting texture 3 in the tread, the texture 3 having a plurality of elements that protrude from or are recessed into the surface of the groove.

The invention is not limited to the examples described and shown and various modifications can be made thereto without departing from its scope.

Thus, according to another non-limiting variant embodiment, the lamellae 7 from FIG. 5 can be discontinuous. They have a flat part between one another. They can also have cross-sectional differences between one another. In addition, the lamellae can have curves or angles, notably along their length. They can also have a variable length.

Thus, according to another variant embodiment, the openings 11 can have a circular, square or polygonal (for example hexagonal) shape and the corresponding cavities 12 can have a cylindrical, parallelepipedal or polygonal shape. With these two latter structures (square or polygonal), it is possible to more easily organize the openings 11 with respect to one another so as to limit the area of the intermediate regions 13 between these openings. With such opening shapes, it is easier to achieve consistent rates of occupation of the openings.

Thus, the invention described has notably the following advantages:
The texture 3 makes it possible to conceal the level lines in the grooves 21;
The texture 3 (regardless of whether it has protruding elements and/or recessed elements) makes it possible at the same time to absorb light and thus to give the grooves 21 a blacker appearance compared with the rest of the tread 2. This improves the contrast of the grooves 21 with respect to the rest of the tread;
The texture 3 makes it possible to obtain a visual appearance of the “velvet” type at the grooves 21, this providing an effect of contrast and depth in the grooves 21 such that they appear deeper to an observer.

1. A tread for a tire, said tread having a tread surface and a plurality of grooves, at least one of said grooves having, in cross section, an undulating overall shape with entirely open groove parts at the tread surface and completely or partially closed groove parts at said tread surface, wherein the open groove parts comprise a contrasting texture in the tread, the texture having a plurality of elements that protrude from or are recessed into the surface of the groove, and wherein the texture is absent from the closed groove parts.

2. The tread according to claim 1, wherein at least 30% of the protruding elements of the texture form an angle α of greater than 40° with respect to a plane tangent to the surface of the groove, and wherein at most 25% of the protruding elements of the texture form an angle α of less than 20° with respect to the tangent plane.

3. The tread according to claim 1, wherein all or some of the protruding elements are strands distributed through the texture at a density at least equal to one strand per square millimetre (mm²), each strand having a mean cross section of between 0.003 mm² and 1 mm².

4. The tread according to claim 1, wherein all or some of the protruding elements are substantially mutually parallel lamellae, the spacing of the lamellae in the texture being at most equal to 0.5 mm, each lamella having a mean width of between 0.03 mm and 0.25 mm.

5. The tread according to claim 1, wherein all or some of the protruding elements form parallelepipeds having a side length of between 0.05 mm and 0.5 mm and a height of between 0.05 mm and 0.5 mm, the distance between two adjacent parallelepipeds in the texture being between 0.05 mm and 0.5 mm.

6. The tread according to claim 1, wherein the protruding elements have variable shapes and distances between protruding elements in the texture.

7. The tread according to claim 1, wherein the recessed elements form openings in the surface of the groove and the texture comprises a plurality of openings, these openings being distributed through the texture at a density at least equal to one opening per square millimetre (mm²), these openings having equivalent diameters of between 0.03 mm and 1.2 mm.

8. A tire comprising the tread according to claim 1.
